(19) United States
(12) Patent Application Publication
(10) Pub. No.: US 2012/0048689 A1
(43) Pub. Date: Mar. 1, 2012

(54) LINK FOR A LINK CONVEYOR

(76) Inventor: Stefan Hastem-Mueller, Noerdlingen (DE)

(21) Appl. No.: 13/318,358

(22) PCT Filed: May 5, 2010
(86) PCT No.: PCT/EP2010/002762

§ 371 Date: Oct. 31, 2011

(30) Foreign Application Priority Data
May 7, 2009 (DE) 10 2009 020 304.4

(51) Int. Cl. B65G 15/30; B25B 7/02

(52) U.S. Cl. 198/844.1; 81/426

(57) ABSTRACT

The invention relates to a link (2-4) for a link conveyor (1), particularly for a transport link conveyor, having at least one plug element (5, 6) for positively latching to a complementary plug element (5, 6) of a further adjacent link (2-4) of the link conveyor (1).

The invention relates to a novel link for a link conveyor, particularly for a transport link conveyor. Furthermore, the invention relates to a link conveyor assembled from such links and a link conveyor system exhibiting one such link conveyor.

Known in the art is the use of conveyor belts for the transporting of unit loads, which conveyor belts may be link conveyors by design and may comprise numerous links which links are connected together in a form-fit. In the case of the prior art link conveyors the form-fit connection between the adjacent links is formed by means of a pin connection. For this reason the individual links exhibit finger-like projections, which finger-like projections project in the direction of travel of the conveyor wherein the finger-like projections of the adjacent links in the mounted state interlock with one another like fingers and include transversely traveling bore holes into which the connecting pin is pushed in order to positively connect the adjacent links.

The first disadvantage in the case of the presently described conventional link conveyors having a pin connection is the fact that the creation of the pin connection requires not only the two links to be connected together but also an additional component in the form of the connecting pin.

A further disadvantage of the prior art pin connection is that to release the pin connection a tool is generally required to remove the connecting pin.

Furthermore the connecting pins in the case of the conventional pin connections of link conveyors are difficult to release after just a short running time.

Finally, in the case of the prior pin connections it must be ensured that the connecting pin does not work itself loose again in operation as may be caused for example by the vibrations occurring when the system is running. The prior art pin connections of link conveyors therefore require additional lateral securing means, which prevent the connecting pins from lateral axial migration in operation.

The object of the invention is therefore to achieve an improved link for a link conveyor.

This object is achieved by a link according to the invention in accordance with the main claim.

The invention comprises the general technical tenet of connecting adjacent links of a link conveyor together not by means of a conventional pin connection but by means of a positive push-fit connection, which push-fit connection comprises a push-fit element on one link and a compatibly formed push-fit element on the other link. This offers the advantage in comparison to the prior art pin connection mentioned at the outset that no additional connection element (e.g. pin) is necessary.

In one variant of the invention the push-fit connection is a tongue and groove connection wherein the link exhibits a tongue, which tongue can be pushed into a compatibly form-adapted groove on the other link in order to form the tongue and groove connection.

The push-fit connection however is preferably a latching connection comprising two complementary latching elements on the adjacent links. The link according to the invention therefore exhibits in this embodiment at least one latching element in order to connect the link by means of the positive latching connection to the complementary latching element of a further adjacent link of the link conveyor.

In this case it should be mentioned that the term latching connection used in the context of the invention also encompasses snap-fitting connections.

In a preferred exemplified embodiment of the invention the link exhibits two complementary latching elements at opposite ends of the link with respect to the direction of travel of the conveyor such that several identical links can be assembled to form the link conveyor wherein the complementary latching elements are respectively latched together in pairs.

In the preferred exemplified embodiment of the invention the link also exhibits a toothing arrangement, which toothing arrangement may be disposed optionally on the inside or outside wherein the complimentary latching elements of two adjacent links in the assembled state respectively form in pairs a tooth of the toothing arrangement. The individual latching elements are therefore formed such that they form one portion of a tooth of the toothing arrangement wherein the complimentary latching elements are adapted in terms of their form such that they form a tooth in the assembled state.

The latching connection is hereby preferably formed such that the assembled link conveyor at the junctions of adjacent links exhibits a substantially smooth, indentation-free, unbroken and/or level external surface or internal surface.

It should be mentioned furthermore that the latching connection exhibits a specific latching direction wherein the complementary latching elements must be moved in opposite directions for the purposes of connecting or separating.

In one variant of the invention the latching direction is aligned transversely with respect to the plane of the conveyor, particularly at right angles with respect to the plane of the conveyor. This means that the complementary latching elements must be moved in opposite directions transversely with respect to the direction of the conveyor in order to connect together or separate from one another the complementary latching elements.

In another variant of the invention the latching direction however runs parallel to the plane of the conveyor and/or parallel with respect to the direction of travel of the conveyor. This means accordingly that for the purposes of connecting or separating the complementary latching elements must be moved parallel with respect to the plane of the conveyor and/or parallel with respect to the direction of travel of the conveyor in opposite directions in order to connect together or separate from one another the complementary latching elements.

In the context of the invention however the aforementioned first variant according to which the latching connection direction is aligned transversely with respect to the plane of the conveyor is preferred. This is advantageous because tensile forces acting in the direction of travel of the link conveyor in operation cannot lead in the event of a transverse alignment of the latching connection direction to an inadvertent disconnection of the latching connection.

It should be mentioned furthermore that the latching connection is preferably toollessly releasable and can be toollessly joined. This means that the complementary latching elements can be manually latched and separated from one another, which simplifies assembly.

It should be mentioned furthermore that the latching connection can be created with a specific joining force while a specific separation force is required to separate the latching connection. The latching connection is preferably constructed such that the separation force required to separate the complimentary latching elements is greater than the joining force required to connect the complimentary latching elements. Such a construction of the latching connection combines the benefit of easy assembly with low operating forces with the benefit of good mechanical loading capacity in the assembled state.

In one variant of the invention the link and thereby also the assembled link conveyor exhibit a smooth external surface, which can be advantageous depending on the unit loads or bulk material to be conveyed.

In another variant of the invention however the external surface of the link and thereby also the external surface of the assembled link conveyor is textured. For this purpose the link may be provided with a hole or a driver as per the prior art. The driver may comprise for example a brush, needle, an elastic lip transversely aligned with respect to the direction of travel of the conveyor or glued belts or strips of various materials such as fabric, synthetic leather, rubber, silicone or foam. The external surfaces may also be textured by applying soft synthetic materials such as soft PVC (Polyvinyl chloride) or TPE (thermoplastic elastomer).

It should be furthermore mentioned that the link according to the invention is preferably homogeneous in terms of material. This means that the link comprises a single part of a single, uniform material for the ease of cost effective mass production.

For example, the link may consist at least partially of plastics, particularly plastic canvas, textile fabric, polyvinyl chloride (PVC), acrylonitrile butadiene styrene (ABS), thermoplastic elastomer (TPE), polypropylene (PP), urethane, polyethylene (PE), polyoxymethylene (POM), polybutene terephthalate (PBT) or polyamide (PA). It is also possible however that the link according to the invention may consist at least partially of metal or stainless steel, particularly metal fabric.

Furthermore, it is possible within the context of the invention that the link consists of different materials, which may vary for example in terms of their hardness and elasticity. For example the link may comprise a combination of a relatively hard ABS and relatively elastic TPE wherein the link may consist of one or a plurality of parts.

In one variant of the invention the link exhibits in addition to the latching element a transverse groove traveling transversely with respect to the direction of travel of the conveyor to form the form-fit connection of the link to an adjacent link, which adjacent link exhibits a correspondingly adapted and laterally traveling with respect to the direction of travel of the conveyor tongue, which tongue can be pushed into the lateral groove in order to form the form-fit connection. In such a design the link according to the invention therefore exhibits at both its opposite ends with respect to the direction of travel of the conveyor different connecting elements namely at one end a latching element for the creation of a latching connection and at the other end the transverse groove for the creation of the positive pin-like connection. In this case the assembled link conveyor does not comprise identical links but different links, which different links are described in detail below.

The transverse groove in the link hereby preferably exhibits a round internal cross-section while the tongue in the adjacent link exhibits a correspondingly adapted round external cross-section such that the tongue can be pushed transversely with respect to the direction of travel of the conveyor and thereby axially with respect to the transverse groove into the transverse groove in order to create the positive connection between the adjacent links.

The transverse groove in this case preferably passes in the direction of travel of the conveyor into a slot transversely traveling with respect to the direction of travel of the conveyor through which slot travels in the assembled state a material web of the adjacent link, wherein the material web connects the tongue of the adjacent link to the remainder of the adjacent link. The slot travels preferably obliquely with respect to the external surface, particularly in an angle of approximately 45° with respect to the external surface, which has been proven to be advantageous.

It should be mentioned furthermore that the invention is not limited to the presently described inventive link as an individual component but also protection is claimed for a complete link conveyor assembled from such links.

The link conveyor is preferably a conveyor belt for the transportation of unit loads by design. It is also alternatively possible however that the link conveyor according to the invention is a conveyor belt to feed bulk material by design. There is also the opportunity furthermore that the link conveyor according to the invention acts as a drive belt for power transmission in a belt drive.

With respect to the design of the link conveyor according to the invention there exist various options. The link conveyor may be for example a toothed belt, a round belt, a V-ribbed belt or a flat belt by design to name just a few examples.

In the case of this kind of link conveyor it is self-evident that a plurality of links are disposed one after another in the direction of travel of the conveyor. It is also possible however that the link conveyor comprises a plurality of links disposed side-by-side with respect to the direction of travel of the conveyor, whereby the belt width would increase.

In such a side-by-side arrangement of a plurality of links it is possible that the links of the conveyor being consecutively disposed in the direction of travel are laterally offset with respect to each other.

It was mentioned at the outset in the description of the link according to the invention that the finished link conveyor may optionally comprise identical or different links. It may therefore be advantageous if the link conveyor comprises different links, which links are substantially rigid or substantially elastic. In this case the individual elastic links in the direction of travel of the conveyor are preferably flanked by two adjacent rigid links wherein the elastic links are connected by means of a positive and/or flush fitting connection to the rigid links while the rigid links are respectively connected together in pairs by means of the latching connection.

Finally, the invention also claims protection for a link conveyor system such as for example a transport system or a belt drive. The link conveyor system according to the invention exhibits the presently described link conveyor according to the invention and two deflection rollers wherein one or both deflection rollers can be driven. Furthermore, the link conveyor in the case of the link conveyor system according to the invention preferably exhibits an internal toothing wherein beneath the upper run of the link conveyor may be disposed a sliding guide on which the internal toothing of the link conveyor slides along.

Furthermore, the link conveyor system according to the invention may exhibit a lateral guide in order to prevent lateral migration of the link conveyor on the deflection rollers. The lateral guide can be arranged in this case such that only an overlap occurs between the lateral guide and the internal toothing whereas the lateral toothing does not reach the external surface of the link conveyor.

Finally, the invention also comprises dismantling pliers, which are designed to release the latching connection of the adjacent links.

These dismantling pliers according to the invention preferably exhibit an open mounting slot at the head end into which mounting slot the link conveyor can be inserted during dismantling. The dismantling pliers are thus pushed laterally onto the link conveyor during dismantling in the region of two mutually latched links wherein the mounting slot accommodates the link conveyor. The above-mentioned mounting slot for the link conveyor preferably travels at right angles with respect to the plane of rotation of the two lever arms.

The dismantling pliers according to the invention preferably have two one-ended lever arms, which are mutually rotatably connected at their distal ends by means of an articulation. It is however alternatively also possible that like normal pliers the dismantling pliers according to the invention comprise two two-ended lever arms, which lever arms form two handles at one end and the pliers head at the opposite end.

Furthermore, it is worth mentioning that the two lever arms of the dismantling pliers according to the invention respectively exhibit a clamping jaw in the region of the inside of the pliers head wherein both clamping jaws press in opposite directions from the outside onto the latching element during assembly in order to release the latching connection.

Other advantageous further developments of the invention are identified in the subclaims or are explained in greater detail below with reference to the figures together with the description of the preferred exemplary embodiments of the invention. The figures show as follows:

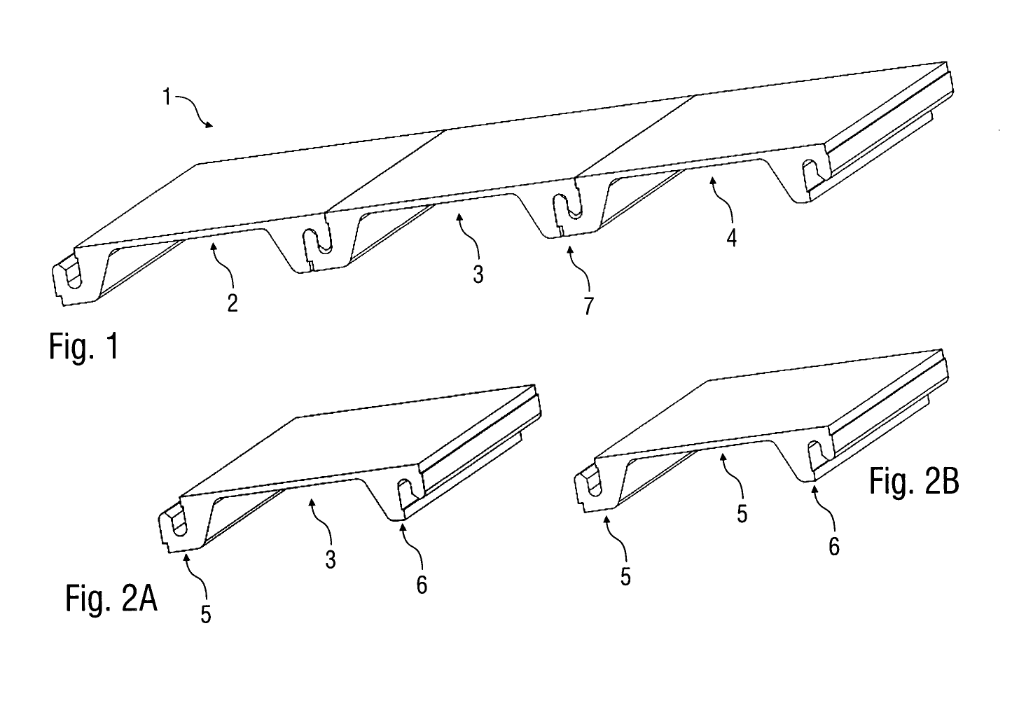

FIG. 1 a perspective view of a link conveyor according to the invention in the assembled state,

FIGS. 2A, 2B perspective views of two identical links of the link conveyor according to FIG. 1 wherein the two links can be connected together by means of a latching connection,

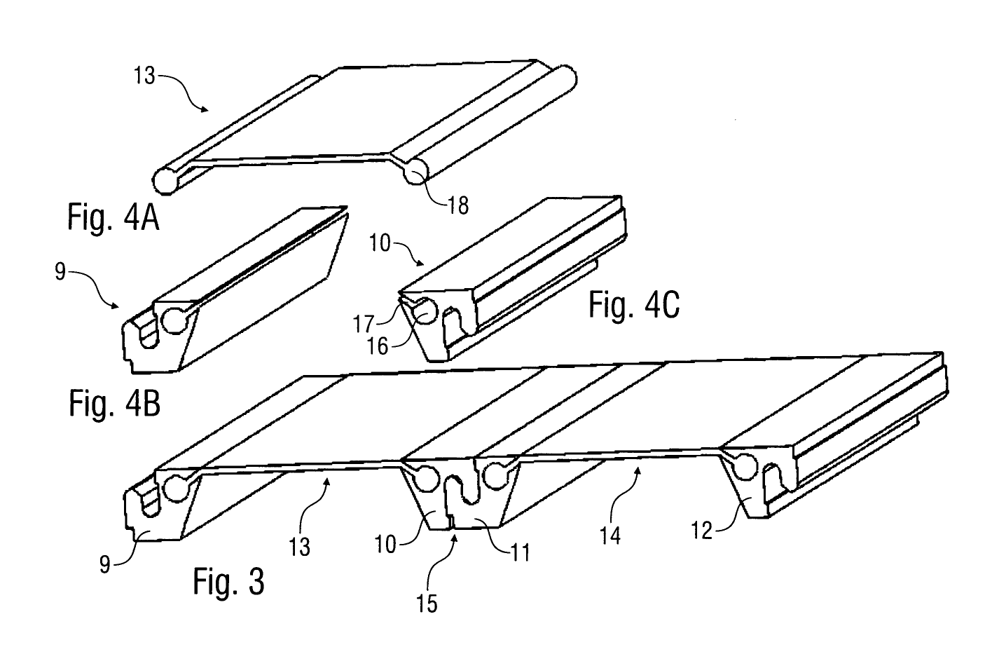

FIG. 3 a perspective view of a further exemplified embodiment of a link conveyor according to the invention in the assembled state,

FIG. 4A a perspective view of an elastic link of the link conveyor according to FIG. 3,

FIGS. 4B, 4C perspective views of rigid links of the link conveyor according to FIG. 3,

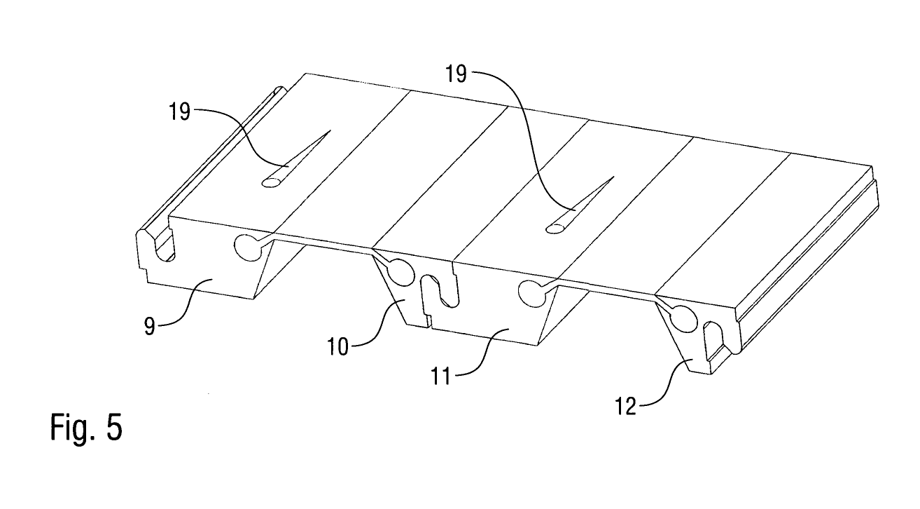

FIG. 5 a perspective view of a modification of the link conveyor according to FIG. 3 with drivers,

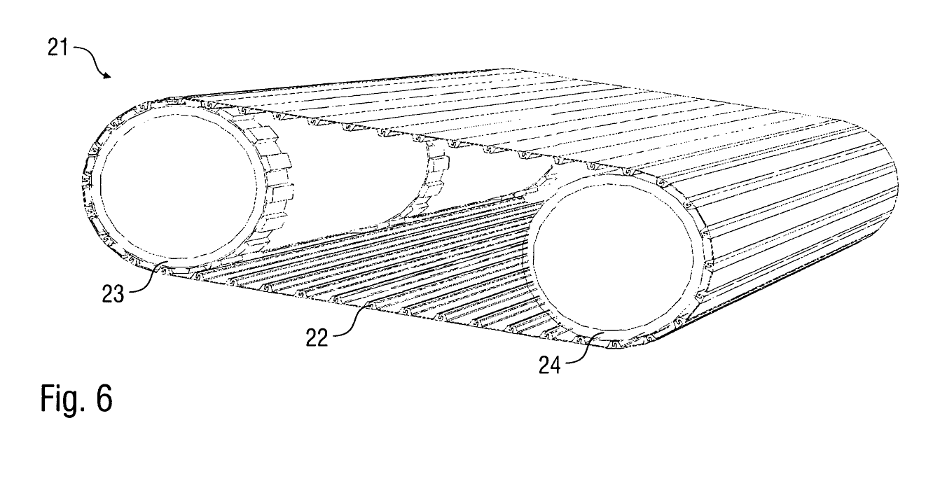

FIG. 6 a perspective view of a link conveyor according to the invention,

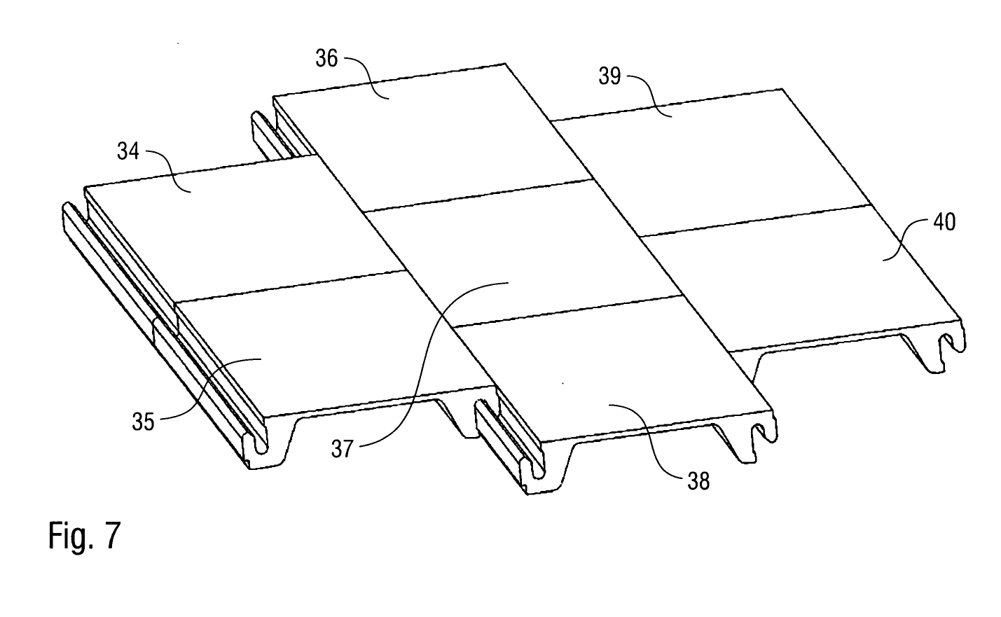

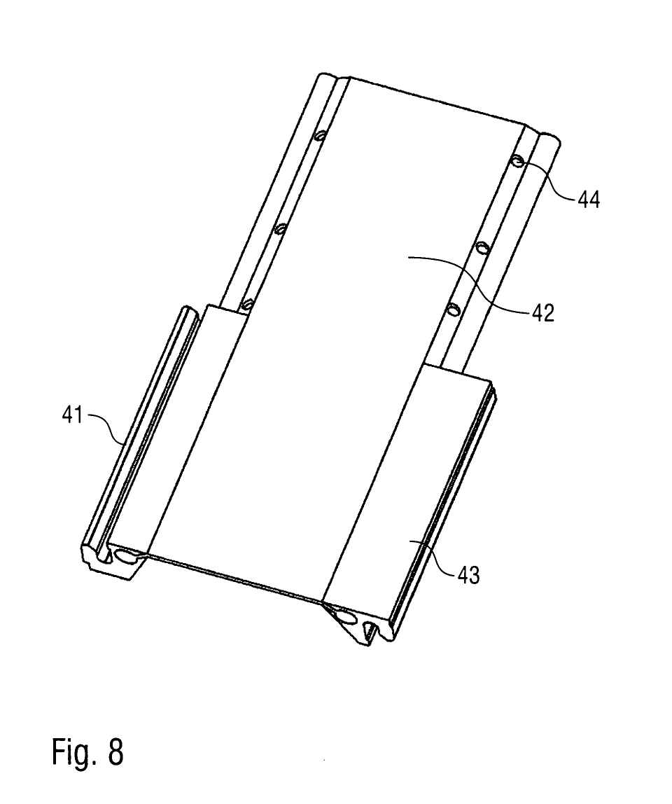

FIG. 7 a perspective view of a portion of a link conveyor according to the invention wherein the consecutively arranged links in the direction of transport are laterally offset with respect to one another,

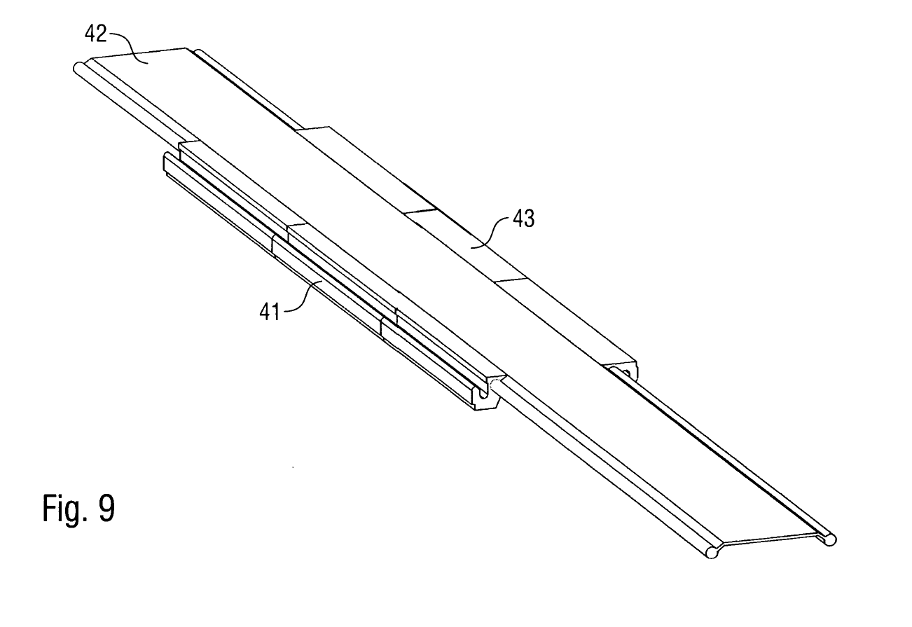

FIG. 8 several links of a link conveyor according to the invention in a perspective view wherein the central link is perforated,

FIG. 9 an alternative perspective view of the exemplified embodiment according to FIG. 8, wherein the central link is not perforated,

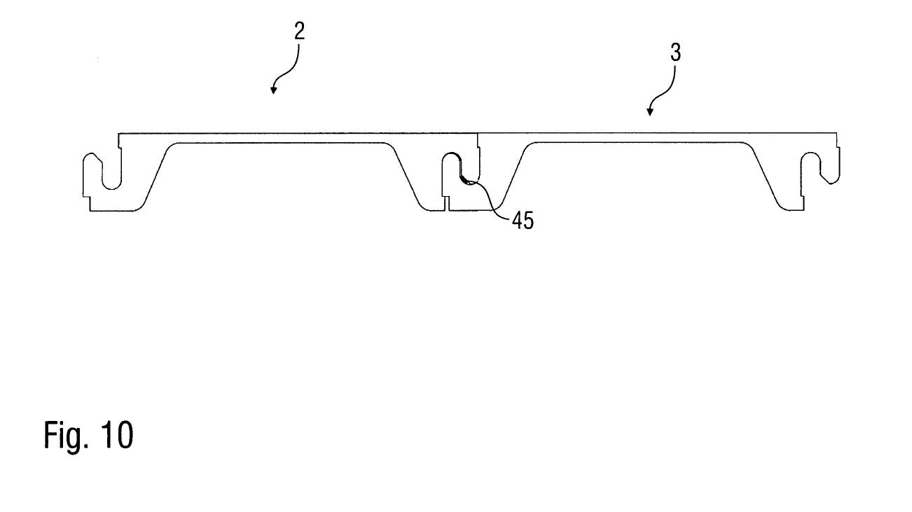

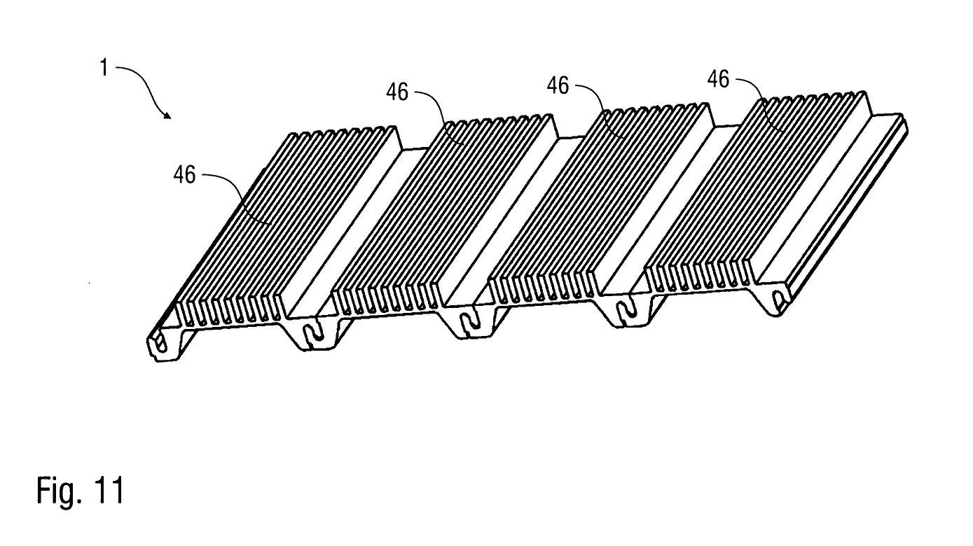

FIG. 10 a lateral view of two links having a latching connection, which latching connection is additionally secured by means of an adhesive connection,

FIG. 11 a perspective view of a portion of a link conveyor according to the invention having lips, which lips project from the transported materials surface,

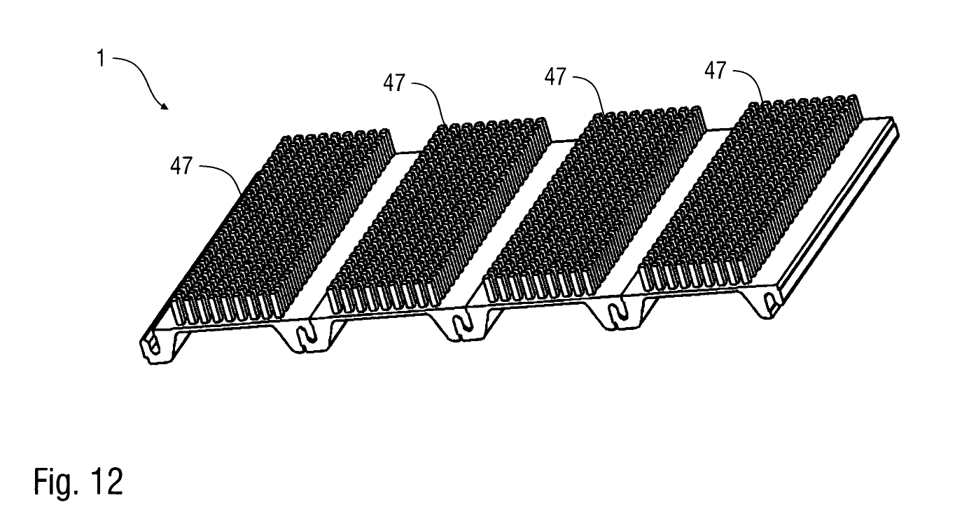

FIG. 12 a modification of FIG. 11,

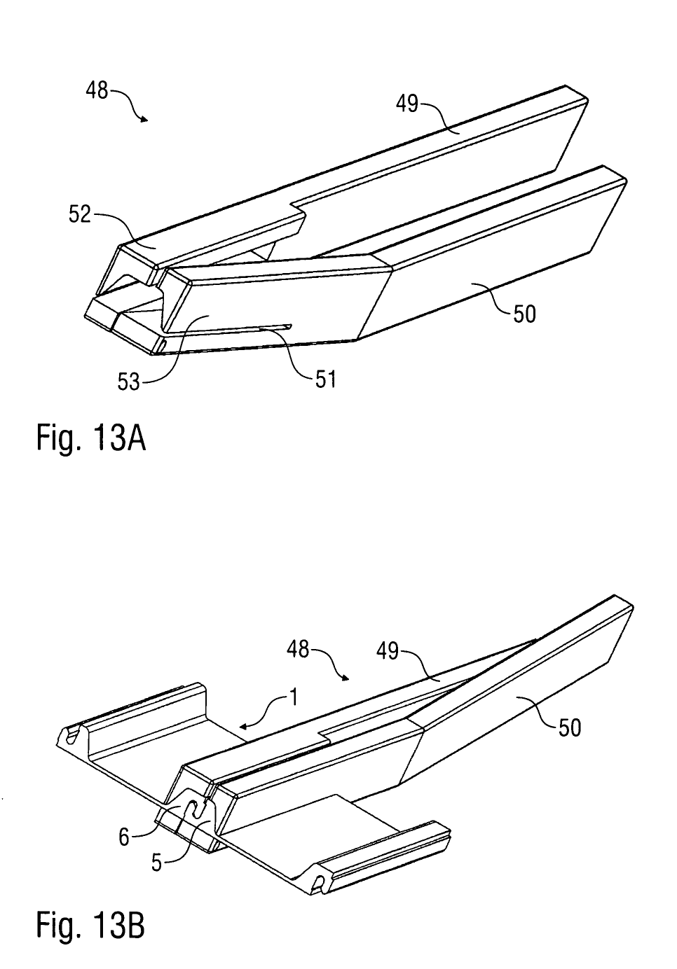

FIG. 13A a perspective view of dismantling pliers according to the invention for the purpose of the dismantling of the link conveyor pursuant to FIG. 1 and

FIG. 13B a perspective view of the dismantling pliers pursuant to FIG. 13A during the releasing of the latching connection.

FIG. 1 shows a link conveyor 1 according to the invention, which link conveyor 1 can be used for example for the transporting of unit loads.

The link conveyor 1 consists of numerous links 2, 3, 4, which can be respectively in pairs positively connected together by means of a latching connection in order to assemble the link conveyor 1.

For this purpose the individual links 2-4 exhibit at opposite ends with respect to the direction of travel of the conveyor complementarily formed latching elements 5, 6 wherein the latching element 6 on the link 3 in the assembled state engages in the latching element 5 on the link 4 and forms a positive latching connection.

For the purpose of creating the latching connection the two latching elements 5, 6 are pushed together transversely with respect to the direction of travel of the conveyor and transversely with respect to the plane of the conveyor, which can occur without tools, which simplifies the assembly of the link conveyor 1. The latching connection between the adjacent links 3, 4 can also be manually separated again wherein the adjacent links 3, 4 of the link conveyor 1 are pulled apart transversely with respect to the plane of the conveyor. In this case it should be mentioned that the joining force required to join the latching elements 5, 6 is substantially less than the separating force required to separate the latching elements 5, 6. The latching connection thus combines the advantage of simple installation with small operating forces with the advantage of a large mechanical loading capacity of the latching connection.

Furthermore, it should be mentioned that the latching direction is aligned at right angles with respect to the direction of travel of the conveyor and at right angles with respect to the plane of the conveyor. This offers the advantage that the tensile forces occurring in the link conveyor 1 in operation cannot lead to an inadvertent releasing of the latching connection.

Furthermore, it should be mentioned that the complementarily formed latching elements 5, 6 in the assembled state respectively in pairs form a tooth 7 of an internal toothing wherein the internal toothing for example permits a driving of the link conveyor 1 by means of a toothed wheel.

FIG. 3 shows a alternative exemplified embodiment of a link conveyor 8 according to the invention comprising a plurality of rigid links 9, 10, 11, 12 and a plurality of elastic links 13, 14.

The rigid elements 10, 11 can in this case be positively connected by means of a latching connection wherein the latching connection functions in the same manner as the latching connection in the exemplified embodiment pursuant to FIG. 1 such that reference is made to the above-mentioned description in this respect.

In this case also the two rigid portions 10, 11 respectively in pairs together form a tooth 15 of an internal toothing wherein a toothed wheel can engage in the internal toothing.

The elastic links 13, 14 on the contrary are connected to the rigid links 9, 10 by means of a positive connection. To this end the rigid portions 9, 10, 11, 12 respectively exhibit a transverse groove 15 having a circular internal cross-section, which transverse groove 15 fits into a slot 17. The elastic links 13 exhibit for the creation of the positive connection to the rigid links 9, 10, 11, 12 at both ends respectively a tongue 18 having a circular external cross-section wherein the tongue 18 can be axially pushed into the transverse groove 16 in order to create the positive connection.

FIG. 5 shows a modification of the exemplified embodiment pursuant to the FIGS. 3, 4A-4C such that to avoid repetition reference is made to the above-mentioned description wherein the same reference numbers are used for the corresponding details.

A particularity of this exemplified embodiment is that on the external surface of the rigid links 9, 11 respectively a mounting sleeve 19, 20 is attached into which respectively a needle can be inserted as a driver.

Finally, FIG. 6 shows a complete transport belt system 21 having a link conveyor 22, a driven toothed wheel 23 and an un-driven deflection roller 24.

It should be mentioned in this case that the toothed wheel 23 exhibits an axial toothing, which axial toothing does not extend over the whole width of the toothed wheel 23.

FIG. 7 shows a perspective view of a portion of a link conveyor according to the invention having a plurality of links 34-40, which plurality of links 34-40 are respectively connected by means of latching connections wherein the type of latching connection has already been described such that to avoid repetition reference is made to the above-mentioned description.

A particularity of this exemplified embodiment is that several links are disposed side-by-side wherein the links disposed consecutively in the feed direction are laterally offset with respect to one another. For example the link 34 is offset laterally with respect to the links 36, 37.

FIG. 8 shows a perspective view of three links 41-43 of a link conveyor according to the invention wherein the links 41, 43 are made of plastic and are therefore relatively hard while the central link 42 is made of textile material and is therefore relatively elastic.

The link 42 is respectively connected by way of a tongue and groove connection to the adjacent links 41, 43.

Furthermore, it should be mentioned that the central elastic link 42 exhibits holes 44, which holes 44 are advantageous in the case of manufacture in an injection molding machine or in an extruder. In the case of an injection molding or extrusion process plastic flows through the holes 41 wherein the plastic subsequently cools and hardens to constitute an even stronger connection.

FIG. 9 shows the link conveyor according to FIG. 8 in which the elastic link is not perforated.

FIG. 10 shows two links 2, 3 according to the invention, which links 2, 3 largely correspond to the exemplified embodiment pursuant to FIG. 1 such that to avoid repetition reference is made to the above-mentioned description wherein the same reference numbers are used for the corresponding details.

A particularity of this exemplified embodiment is that the latching connection between the adjacent links 2, 3 is additionally secured by an adhesive connection 45.

FIG. 11 shows a perspective view of a link conveyor 1 according to the invention, which largely corresponds to the link conveyor 1 described above and illustrated in FIG. 1 such that to avoid repetition reference is made to the above-mentioned description wherein the same reference numbers are used for the corresponding details.

A particularity of this exemplified embodiment is that the individual links on the side facing the transportation material exhibit lips 46, which lips 46 travel transversely with respect to the direction of feed and are elastically resilient.

The exemplified embodiment according to FIG. 12 largely corresponds to the exemplified embodiment described above and illustrated in FIG. 11 such that in order to avoid repetition reference is made to the above-mentioned description wherein the same reference numbers are used for corresponding details.

A particularity of this exemplified embodiment is that in place of the lips 46 brushes 47 are provided, which brushes 47 respectively individually protrude upwards and may be elastically resilient.

The FIGS. 13A and 13B show dismantling pliers 48 according to the invention for the releasing of the latching connection in the case of the link conveyor 1 according to FIG. 1.

The dismantling pliers 48 exhibit two lever arms 49, 50, which lever arms 49, 50 are jointed at one end and rotate relatively to one another in a rotating plane.

Furthermore, the dismantling pliers 48 exhibit a pliers head having an insert slot 51, which insert slot 51 is open at the head end such that the dismantling pliers 48 can be pushed laterally onto the latched link conveyor 1.

The pliers head of the dismantling pliers 48 furthermore exhibits two clamping jaws 52, 53. When pushing the lever arm 50 down the clamping jaw 53 pushes from above onto the latching element 5 whereby the latching connection releases.

The invention is not limited to the above-described preferred exemplary embodiments. Instead, a plurality of variants and modifications are possible, which also make use of the concept of the invention and thus fall within the scope of protection.

Furthermore, the invention also claims protection in respect of the object of the sub-claims irrespectively of the object of the overriding claims. The object of the sub-claims can thus also be implemented in the context of the invention without the features of the overriding claims.

### LIST OF REFERENCES

1 Link conveyor
2 Link
3 Link
4 Link
5 Latching element
6 Latching element
7 Tooth
8 Link conveyor
9 Rigid link
10 Rigid link
11 Rigid link
12 Rigid link
13 Elastic link
14 Elastic link
15 Tooth
16 Transverse groove
17 Slot
18 Tongue
19 Mounting sleeve
20 Mounting sleeve
21 Conveyor belt system
22 Link conveyor
23 Toothed wheel
24 Deflection roller
34-40 Links
41-43 Links
44 Holes
45 Adhesive connection
46 Lips
47 Brushes
48 Dismantling pliers
49, 50 Lever arms
51 Insert slot
52, 53 Clamping jaws

1-29. (canceled)

30. A link for a link conveyor, comprising at least one push-fit element for creating a positive push-fit connection with a complementary push-fit element of an adjacent further link of the link conveyor.

31. The link according to claim 30, wherein the push-fit connection is a latching connection wherein the at least one push-fit element and the complementary push-fit element are latching elements by design.

32. The link according to claim 30, wherein the push-fit connection is a tongue and groove connection wherein one push-fit element is a tongue while the complementary push-fit element is a groove.

33. The link according to claim 31, further comprising two complementary latching elements at opposite ends of the link in a direction of travel of the conveyor such that a plurality of identical links can be assembled to form the link conveyor.

34. The link according to claim 33, further comprising a toothing arrangement wherein the complementary latching elements of two adjacent links in the assembled state respectively in pairs form a tooth of the toothing arrangement.

35. The link according to claim 34, wherein the toothing arrangement is disposed inside.

36. The link according to claim 34, wherein the toothing arrangement is disposed outside.

37. The link according to claim 31, wherein the latching connection is embodied such that the assembled link conveyor at junctions of adjacent links exhibits a substantially smooth, indentation-free, unbroken and flat external surface or internal surface.

38. The link according to claim 31, wherein
a) the latching connection exhibits a particular latching direction within which the complementary latching elements must be moved in opposite directions for purposes of connection or separation; and
b) the latching direction is aligned transversely with respect to a plane of the conveyor.

39. The link according to claim 31, wherein the latching connection is toollessly releasable and can be toollessly joined.

40. The link according to claim 31, wherein the latching connection can be joined with a particular joining force whereas a particular separating force is required for the separating of the latching connection wherein the required separating force is greater than the joining force.

41. The link according to claim 30, wherein at least one driver is disposed on an external surface of the link.

42. The link according to claim 41, wherein the driver is selected from the group consisting of:
a) a brush,
b) a needle, and
c) a lip transversely travelling with respect to a direction of travel of the conveyor.

43. The link according to claim 41, wherein the external surface comprises glued belts or strips of diverse materials selected from the group consisting of fabric, synthetic leather, rubber, silicone and foam.

44. The link according to claim 41, wherein the external surface is textured by the provision of soft plastics.

45. The link according to claim 30, wherein the link is homogeneous in terms of material.

46. The link according to claim 30, wherein the link at least partially comprises one of the following materials:
plastics, plastics fabric, textile fabric, polyvinyl chloride, acrylonitrile butadiene styrene, thermoplastic elastomers, polypropylene, urethane, polyethylene, polyoxymethylene, polybutylene terephthalate, polyamide, textile fabric, metal and metal fabric.

47. The link according to claim 30, further comprising a transverse groove traveling transversely with respect to a direction of travel of the conveyor for the purpose of positively connecting the link to an adjacent link, which adjacent link exhibits a tongue correspondingly adapted and travelling transversely with respect to the direction of travel of the conveyor, which tongue can be pushed into the transverse groove in order to form the positive connection.

48. The link according to claim 47, wherein
a) the transverse groove exhibits a round internal cross section while the tongue exhibits a correspondingly adapted round external cross section;
b) the transverse groove passes into a slot travelling transversely with respect to the direction of travel of the conveyor, through which in the mounted state a material web of the adjacent link travels, wherein the material web connects the tongue with the remainder of the adjacent link;
c) the slot travels obliquely with respect to an external surface, and
d) the transverse groove and the latching element are disposed at opposite ends of the link.

49. A link conveyor having a plurality of links according to claim 30.

50. The link conveyor according to claim 49, in the form of an embodiment which is selected from the group consisting of:
a) a transport belt for transporting unit loads,
b) a conveyor belt for conveying bulk material, and
c) a drive belt for the purpose of power transmission within a belt drive.

51. The link conveyor according to claim 49, in the form of an embodiment which is selected from the group consisting of:
a) a toothed belt,
b) a round belt,
c) a V-belt,
d) a V-ribbed belt, and
e) a flat belt.

52. The link conveyor according to claim 49, further comprising a plurality of links, which links are disposed side-by-side with respect to a direction of travel of the conveyor.

53. The link conveyor according to claim 52, wherein the conveyor links being consecutively disposed with respect to the direction of travel are laterally offset with respect to one another.

54. The link conveyor according to claim 49, wherein the link conveyor comprises different links, which are either substantially rigid or substantially elastic.

55. The link conveyor according to claim 54, wherein
a) the individual elastic links in the direction of travel of the conveyor are respectively flanked by two adjacent rigid links;
b) the elastic links are connected by a positive and flush fitting connection to the rigid links; and
c) the rigid links are connected together respectively in pairs by the latching connection.

56. A link conveyor system having
a) a link conveyor according to claim 49 having an upper run and a lower run;
b) two deflection rollers around which the link conveyor is guided; and
c) an internal toothing of the link conveyor.

57. The link conveyor system according to claim 56, further comprising a sliding guide, which sliding guide is disposed beneath the upper run and slides along on the internal toothing of the upper run.

58. The link conveyor system according to claim 56, further comprising a lateral guide, which lateral guide is disposed laterally adjacent to the internal toothing on one side or both sides.

59. Dismantling pliers for releasing the latching connection between two links according to claim 30.

60. The dismantling pliers according to claim 59, further comprising a pliers head having an open mounting slot at the head end, into which open mounting slot the link conveyor can be inserted during assembly.

61. The dismantling pliers according to claim 59, further comprising two single-ended lever arms, which single-ended lever arms at their distal ends are rotatably connected together by means of an articulation.

62. The dismantling pliers according to claim 61, wherein the lever arms are rotatable in parallel with respect to a latching direction of the latching connection and at right angles with respect to a plane of the conveyor of the link conveyor in order to release the latching connection.

63. The dismantling pliers according to claim 60, wherein the mounting slot for the link conveyor travels at right angles with respect to a rotating plane of the two lever arms.

64. The dismantling pliers according to claim 61, wherein
a) the two lever arms exhibit in an area of an inside of the pliers head one clamping jaw, respectively, and
b) the two clamping jaws press during the dismantling from the outside in opposite directions onto the latching elements in order to release the latching connection.
